(19) United States
(12) Patent Application Publication
(10) Pub. No.: US 2006/0125982 A1
(43) Pub. Date: Jun. 15, 2006

(54) Liquid crystal display

(76) Inventors: Shi-Ping Lin, Daliao Township (TW); Pin Chang, Toufen Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/040,026

(22) Filed: Jan. 24, 2005

(30) Foreign Application Priority Data
Dec. 14, 2004 (TW) 093220118

(51) Int. Cl. G02F 1/1335

(52) U.S. Cl. 349/113

(57) ABSTRACT

A liquid crystal display consists of a first transparent substrate, a first transparent conductive layer, a liquid crystal layer, a second transparent conductive layer, and a second transparent substrate. A color filter can be disposed under the first transparent substrate, over the second transparent substrate or under the second transparent substrate. The color filter is made by a glass substrate printed by a printing method. Furthermore, when the first transparent substrate and the second transparent substrate are glass substrate, the color filter can be printed directly on top side of the first transparent substrate, bottom side of the first transparent substrate, top side of the second transparent substrate or bottom side of the second transparent substrate.

### BACKGROUND OF THE INVENTION

The present invention relates to a liquid crystal display, especially to a color filter arrangement inside the liquid crystal display.

According to difference in drive mode, LCD (liquid crystal display) is broken into two modes-passive drive and active drive. The LCD of front kind simply consists of electrodes and liquid crystal molecules. Screening electrode and data electrode are disposed in matrix form. Being synchronous with scanning signals, a circuitry provides a source drive-voltage for liquid crystal molecules so as to achieve a contrast display.

Different from other self light-emitting displays, liquid crystal cells act as light valves. Voltages applied cause change of the alignment of the liquid crystal molecules so as to control the brightness (luminance) and display gray-level images. According to display lighting, there are three types of LCD nowadays-transmissive type, reflective type, and transflective type.

Transmissive LCDs composed by liquid crystal panels and back lights are illuminated by fluorescent backlighting. A reflective screen forgoes backlighting in favor of a mirror that reflects ambient light to illuminate the display. A reflector behind the LCD panel reflects the incoming light so that there is no need to use back light module. Thus reflective screens have benefits of low energy consumption and reduced manufacturing cost. Reflective screens are typically clear when viewed outdoors with bright sunlight. As a result, reflective screens are ideal for use in portable outdoor gadgets.

Now color displays are mainstream. Thus the color filter for three primary colors-red, green and blue becomes essential material for LCD. By color mixing, full-color displays are formed. There are three subpixels in each pixel, one for red, one for green, and one for blue. Light from back light unit passes through the red, green and blue color filters thus acts as three colorful light sources. This is similar to three electron guns-red, green and blue of traditional cathode ray tube. By applying an electric field, the liquid crystal molecules in cells re-align so that the light polarization and the light transmission also change. It's like in each of the pixels, three various voltages are used to regulate the luminous intensity of red, green and blue subpixels. By change of polarization angle and combination of these three primaries with various intensity in different proportion, pixels with various colors and luminance will produce. Therefore, these pixels-small little dots-make up colorful figures or images.

Refer to FIG. 1, a prior art of liquid crystal display is disclosed. The prior art is composed by a RGB (red, green and blue) color filter 30 is disposed between a first transparent substrate 10 and a second transparent substrate 70, a reflective layer 20, a first transparent conductive layer 40, a liquid crystal layer 50, and second transparent conductive layer 60. “Contrast” means the ratio of light transmission in lightness and in darkness. The larger the ratio is, the clearer the images is. In order to increase the contrast, when a voltage is applied to drive the liquid crystal layer 50, pixels being driven must be in deep darkness. Thus a light shield is used for light leak prevention.

At the same time, in order to avoid color mixing of RGB color materials in color filters, a colorless, light-impermeable light shielding film is disposed between the color materials for light leak prevention and color mixing prevention. Moreover, a drop between the color materials and light shielding film must be planarized. Therefore, four times repeated manufacturing procedures of color filters having exposing, developing and photoresist stripping with photomask, as well as planarization requirement raise the manufacturing cost.

Therefore, the present invention provides a liquid crystal device having a color filter printed by a printing method such as ink jet printing, making a transfer (pad printing), planographic printing, relief printing, screen process printing with lower cost to improve above disadvantages.

### SUMMARY OF THE INVENTION

It is a primary object of the present invention to provide a LCD composed by a first transparent substrate, a second transparent substrate, a liquid crystal layer sandwiched between the first transparent substrate and the second transparent substrate. The first transparent substrate is disposed below the second transparent substrate while a color filter is printed on top or bottom side of the first transparent substrate. The color filter can also be printed on top or bottom side of the second transparent substrate.

It is a further object of the present invention to provide a LCD composed by a first transparent substrate, a second transparent substrate, a liquid crystal layer sandwiched between the first transparent substrate and the second transparent substrate. A glass substrate is to be printed on top or bottom side thereof into a color filter. Then the printed substrate is disposed over or under the second transparent substrate. It can also be disposed under the first transparent substrate.

In order to achieve above objects, the present invention provides a liquid crystal display having a first transparent substrate, a reflective layer, a first transparent conductive layer, a liquid crystal layer, a second transparent conductive layer, and a second transparent substrate. A color filter is disposed under the first transparent substrate, over the second transparent substrate, or under the second transparent substrate. The color filter is made by a glass substrate being printed by a printing method. Moreover, when the first transparent substrate and the second transparent substrate are glass substrate, the color filter can be printed directly on top side of the first transparent substrate, bottom side of the first transparent substrate, top side of the second transparent substrate or bottom side of the second transparent substrate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing of a liquid crystal display in accordance with a prior art;

FIG. 2 is a schematic drawing of a color filter of a liquid crystal display of an embodiment in accordance with the present invention;

FIG. 3 is a schematic drawing of a color filter of another embodiment in accordance with the present invention;

FIG. 4 is a schematic drawing of a color filter of a further embodiment in accordance with the present invention;

FIG. 5 is a schematic drawing of a color filter of a further embodiment in accordance with the present invention;

FIG. 6 is a schematic drawing of a color filter of a further embodiment in accordance with the present invention;

FIG. 7 is a schematic drawing of a color filter of a further embodiment in accordance with the present invention.

### DETAILED DESCRIPTION OF THE PREFFERED EMBODIMENT

Conventional manufacturing process of color filters is by photolithography that goes through mask alignment, exposure, development, and stripping process four times. The material and equipment for manufacturing cause high cost. The photolithography mainly includes three main steps: first is the photoresist coating of three primary colors-red, green, and blue the second is proximity alignment exposure; and the last is development. A spin coating available now or inkjet printing developed by Dai Nippon Printing Co. are all methods of coating photoresist for three primary colors—red (R), green (G), and blue (B). The present invention provides a color filter that is made by a printing process and a glass substrate. The cost is down to one fifth or one sixth.

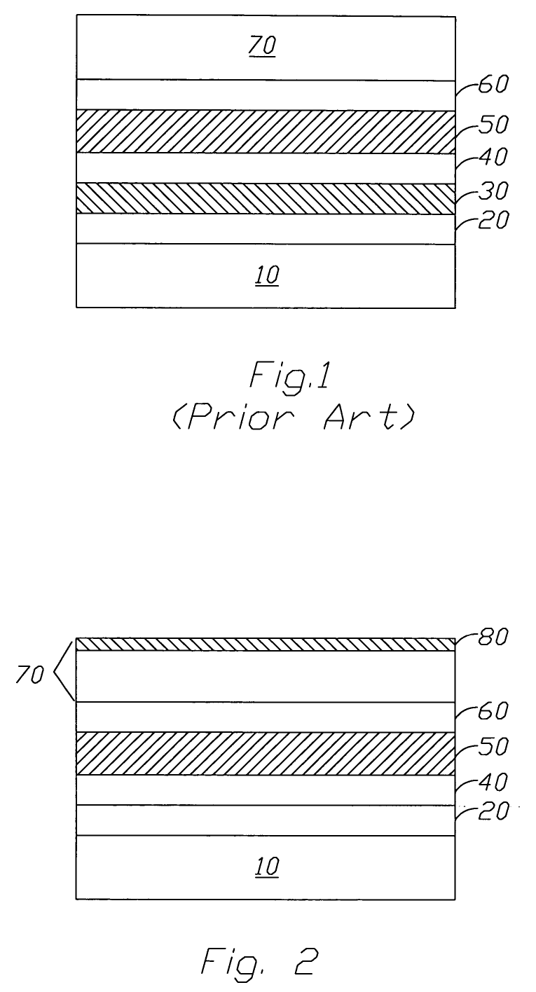

Refer to FIG. 2, a color filter of a liquid crystal display of an embodiment in accordance with the present invention is disclosed. A liquid crystal display according to the present invention includes a first transparent substrate 10, a reflective layer 20, a first transparent conductive layer 40, a liquid crystal layer 50, a second transparent conductive layer 60, and a second transparent substrate 70. The reflective layer 20 is disposed over the first transparent substrate 10 and the first transparent conductive layer 40 is arranged over the reflective layer 20. The liquid crystal layer 50 is disposed over the first transparent conductive layer 40 while the second transparent conductive layer 60 is arranged over the liquid crystal layer 50 and the second transparent substrate 70 is disposed over the second transparent conductive layer 60.

The first transparent substrate 10 as well as the second transparent substrate 70 can be glass substrate, plastic substrate, an indium tin oxide (ITO) substrate or an indium zinc oxide (IZO) substrate. Types of the liquid crystal layer 50 include super twisted nematic (STN), twisted nematic (TN), or Bistable Twist Nematic (BiNem). The reflectance of the reflective layer 20 ranges from 15% to 95%.

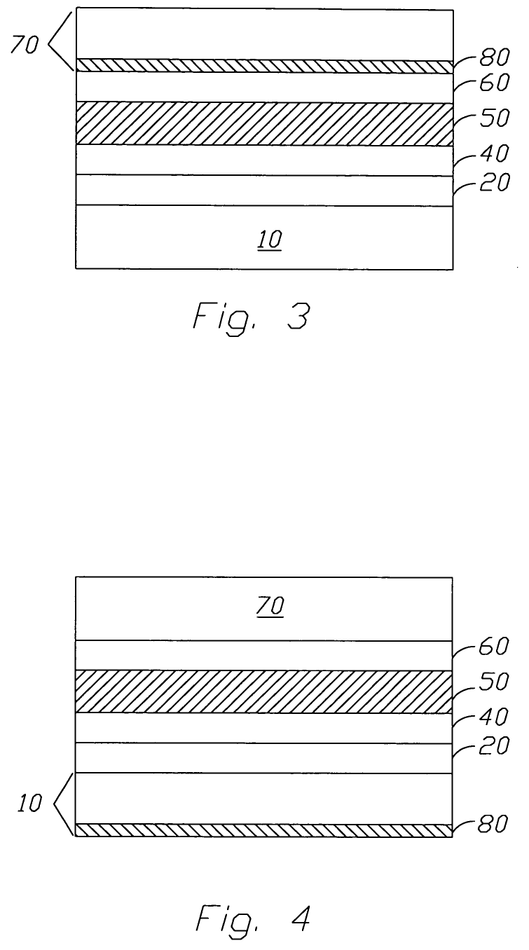

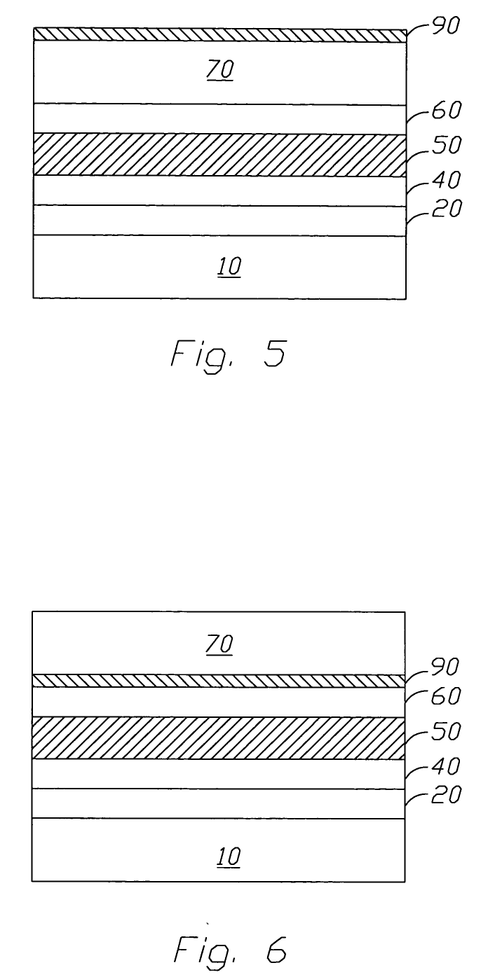

Furthermore, the present invention further includes a color filter 80 that is printed on the top surface of the second transparent substrate 70 (as shown in FIG. 2), or is printed on the bottom surface of the second transparent substrate 70 (as shown in FIG. 3). The color filter 80 can also be printed on the bottom surface of the first transparent substrate 10 (as shown in FIG. 4). The printing method can be ink jet printing, pad printing, planographic printing, relief printing, screen process printing, and so on.

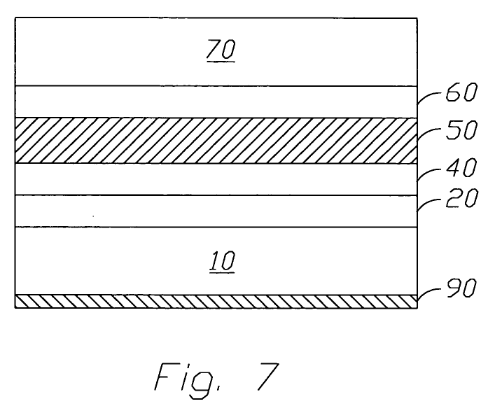

Refer to FIG. 5, a color filter of another embodiment of the present invention is disclosed. The color filter is made by a glass substrate being printed. The color filter 90 is disposed over the second transparent substrate 70 (as shown in FIG. 5), or is arranged under the second transparent substrate 70 (as shown in FIG. 6). The color filter 90 can also be disposed under the first transparent substrate 10 (as shown in FIG. 7). The printing way can be ink jet printing, pad printing, planographic printing, relief printing, screen process printing, and so on.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A first transparent substrate,
a first transparent conductive layer disposed over said first transparent substrate,
a liquid crystal layer arranged over said first transparent conductive layer,
a second transparent conductive layer arranged over said liquid crystal layer,
and a second transparent substrate disposed over said second transparent conductive layer,
wherein a color filter is printed on top side of said first transparent substrate, bottom side of said first transparent substrate, top side of said second transparent substrate or bottom side of said second transparent substrate.

2. The device according to claim 1, wherein said first transparent substrate is a glass substrate.

3. The device according to claim 1, wherein said first transparent substrate is a plastic substrate.

4. The device according to claim 1, wherein said first transparent conductive layer is made of indium tin oxide (ITO) or an indium zinc oxide (IZO).

5. The device according to claim 1, wherein said liquid crystal layer is super twisted nematic (STN), twisted nematic (TN), or Bistable Twist Nematic (BiNem).

6. The device according to claim 1, wherein a reflective layer is disposed over said first transparent substrate.

7. The device according to claim 6, wherein reflectance of said reflective layer ranges from 15% to 95%.

8. The device according to claim 1, wherein said second transparent conductive layer is made of indium tin oxide (ITO), an indium zinc oxide (IZO), or metal.

9. The device according to claim 1, wherein said second transparent substrate is a glass substrate.

10. The device according to claim 1, wherein said second transparent substrate is a plastic substrate.

11. The device according to claim 1, wherein said color filter is printed on top or bottom side of said second transparent substrate by ink jet printing.

12. The device according to claim 1, wherein said color filter is printed on top or bottom side of said second transparent substrate by pad printing.

13. The device according to claim 1, wherein said color filter is printed on top or bottom side of said second transparent substrate by planographic printing.

14. The device according to claim 1, wherein said color filter is printed on top or bottom side of said second transparent substrate by relief printing.

15. The device according to claim 1, wherein said color filter is printed on top or bottom side of said second transparent substrate by screen process printing.

16. A liquid crystal display comprising
a first transparent substrate,
a first transparent conductive layer disposed over said first transparent substrate,
a liquid crystal layer arranged over said first transparent conductive layer,
a second transparent conductive layer arranged over said liquid crystal layer, and a second transparent substrate disposed over said second transparent conductive layer,
wherein a color filter made by being printed on a glass substrate or a plastic substrate is disposed under said first transparent substrate, over said second transparent substrate or under said second transparent substrate.

17. The device according to claim 16, wherein said first transparent substrate is a glass substrate.

18. The device according to claim 16, wherein said first transparent substrate is a plastic substrate.

19. The device according to claim 16, wherein said first transparent conductive layer is made of indium tin oxide (ITO) or an indium zinc oxide (IZO).

20. The device according to claim 16, wherein said liquid crystal layer is super twisted nematic (STN), twisted nematic (TN), or Bistable Twist Nematic (BiNem).

21. The device according to claim 16, wherein a reflective layer is disposed over said first transparent substrate

22. The device according to claim 21, wherein reflectance of said reflective layer ranges from 15% to 95%

23. The device according to claim 16, wherein said second transparent conductive layer is made of indium tin oxide (ITO), an indium zinc oxide (IZO), or metal.

24. The device according to claim 16, wherein said second transparent substrate is a glass substrate.

25. The device according to claim 16, wherein said second transparent substrate is a plastic substrate.

26. The device according to claim 16, wherein said color filter is printed on top side of said glass substrate, bottom side of said glass substrate, top side of said plastic substrate, or bottom side of said plastic substrate by ink jet printing.

27. The device according to claim 16, wherein said color filter is printed on top side of said glass substrate, bottom side of said glass substrate, top side of said plastic substrate, or bottom side of said plastic substrate by pad printing.

28. The device according to claim 16, wherein said color filter is printed on top side of said glass substrate, bottom side of said glass substrate, top side of said plastic substrate, or bottom side of said plastic substrate by planographic printing.

29. The device according to claim 16, wherein said color filter is printed on top side of said glass substrate, bottom side of said glass substrate, top side of said plastic substrate, or bottom side of said plastic substrate by relief printing.

30. The device according to claim 16, wherein said color filter is printed on top side of said glass substrate, bottom side of said glass substrate, top side of said plastic substrate, or bottom side of said plastic substrate by screen process printing.
